(19) United States
(12) Patent Application Publication
(10) Pub. No.: US 2002/0097350 A1
(43) Pub. Date: Jul. 25, 2002

(54) Thin film transistors suitable for use in flat panel displays

(76) Inventors: Duane A. Haven, Escondido, CA (US); W. Edward Naugler JR., Escondido, CA (US)

Correspondence Address: FLEHR HOHBACH TEST ALBRITTON & HERBERT LLP, Suite 3400, Four Embarcadero Center, San Francisco, CA, 94111-4187, US

(21) Appl. No.: 09/952,777

(22) Filed: Sep. 14, 2001

Related U.S. Application Data
(60) Provisional application No. 60/233,805, filed on Sep. 19, 2000.
(60) Provisional application No. 60/297,941, filed on Jun. 12, 2001.

(51) Int. Cl. G02F 1/136

(52) U.S. Cl. 349/43

(57) ABSTRACT

A flat panel display is described. The flat panel display includes a matrix of light-emitting diodes which are driven by thin film field effect transistor circuits in which the channel electrodes of the field effect transistors are cadmium selenide.

### RELATED APPLICATIONS

This application claims priority to U.S. Provisional Application Serial Nos. 60/233,805 filed Sep. 19, 2000 and 60/297,941 filed Jun. 12, 2001.

### BRIEF DESCRIPTION OF THE INVENTION

This invention relates generally to thin film transistors for use in flat panel displays and more particularly to thin film transistors using cadmium selenide as the active semiconductor in pixel drive circuits and peripheral drive circuits.

### BACKGROUND OF THE INVENTION

A flat panel display consists of rows and columns of pixels that determine the resolution of the image. The contrast, color and pattern are controlled by the brightness and color of each individual pixel. The number of rows and columns in present day flat panel displays can vary from a few columns and a few rows for alpha-numeric displays found in watches, radios and entertainment equipment to thousands of rows and columns found in high-density television and high-resolution graphics displays.

For example, a typical VGA display has 640 times three colors (red, green and blue) columns and 480 rows of pixels for a total count of 921,600 pixels. Thin film sample and hold circuits are associated with each pixel to receive a voltage signal representing the image input data and store it at each pixel as the data is scanned into the display. The voltage value is applied to a power FET (field effect transistor), which controls current or voltage to the pixel imaging material.

In the case of a flat panel display which used liquid crystal cells, only one transistor and a storage capacitor are required for the sample and hold circuit. FIG. 1 shows three-columns by three-rows of a display. There are nine pixels 11 and each pixel has a defining address. The upper left pixel is addressed by the column 1 electrical line 12 and by the row 1 electrical line 13. The column line carries the voltage which determines the voltage level for the liquid crystal cell 14. The storage capacitor 18 stores the voltage until a refresh signal renews the voltage and changes it. The row line 13 applies a voltage to the gate of FET 17. Sometimes this line is referred to as the row enable line since, by applying a voltage to all the gate in a row, data is enabled to be applied to the individual liquid crystal cells 14, and the storage capacitor 16 in each row.

The liquid crystal display (LCD) requires virtually no power because the LCD pixel is a capacitor and does not short the power transistor to ground. The only power used in the system is during the charging of the pixel and storage capacitor. As is well-known, LCDs are produced using front and back glass plates that trap the liquid crystal material between them.

In the late 1970s, the display industry decided that in order for displays to be used in portable computers having good resolution (VGA) color displays, an active matrix display would be required. Referring to FIG. 2, each pixel of the active matrix displays includes light-emitting diodes 24 driven by a circuit including transmission gates 21, storage capacitors 22, and power FETs 23. The drain of each power FET 23 is connected to the anode of the light-emitting diode (LED) 24. The cathode of LED 24 is connected to ground. In operation, signal data is stored line by line in buffers 26a and 26b. Buffer 26a feeds signal data to the odd column lines (1, 3, 5, etc.), represented by 27a. Buffer 26b feeds signal data to the even lines (2, 4, 6, etc.), represented by 27b. Which pixel is to receive the data from the buffers is determined by row selector 28. As the signal data arrives at the matrix, first buffer 26 is filled with the first line of the display frame. When the complete first line is in buffer 26, the row selector places a signal on columns 27. This row signal opens all the transmission gates 21 in the first row 29, and the data stored in buffer 26 is downloaded and stored as a voltage in storage capacitor 22 of each pixel. The total storage capacitance is the sum of the metal connection lines, the gate capacitance of output FET 23, and the capacitance of the storage capacitor 22. The storage duration is determined by the RC time constant calculated by the reverse resistance of transmission gate 21, plus the storage capacitance 22, leakage resistance times the total storage capacitance. The storage RC constant should be at least three times the frame duration in time. For example, if the signal data consists of sixty (60) frames per second, the frame duration time is 16.7 ms and the RC constant should be 49.5 ms or greater. Therefore, frame rate plus the total reverse leakage resistance determines the size of the total storage capacitance.

The voltage level +V and duration placed on the gate of output FET 23 determines the perceived brightness of LED 24. This means that there are two ways to effect brightness (gray scale). The first is by storing the value of voltage level of the display voltage on storage capacitor 22. The second way is to break the display frame into eight (8) binary sub-frames that can be combined in 256 ways to give varying time durations of the voltage signal on storage capacitor 22. This is called 8-bit gray scale. Ten (10)-bit gray scale would have 1024 sub-frames.

As one can see, the switching quality of the FET transmission gate 21 is critical and the power capability of output FETs 17, FIG. 1, and 21, FIG. 2. Switching quality is determined by the on resistance of the transmission gate 21 divided into the off (leakage) resistance of the transmission gate 21. Present materials used to fabricate active matrix transmission gates and power transistors are amorphous silicon (a-Si) and polysilicon (p-Si). These popular materials for making thin film circuits are difficult to use, make low performance switches, have low power capability, and require manufacturing temperatures too high for compatibility with plastic substrates. The integrated circuit industry early-on settled for single crystalline silicon as the standard semiconductor material, but single crystalline (monolithic) silicon could not be used for the active matrix in an LCD, because the display had to be spread over the larger area than an IC could cover. Today, a-Si is used in all laptop and notebook high-resolution color displays and is also making inroads into the computer desktop monitor market. In the case of high-resolution displays, the rows and columns are so close together that making the thousand interconnections from the display to the computer control circuits is difficult. Note that the VGA color display has 1920 RGB columns and 480 rows for a total of 2400 connections. In order to eliminate most of these connections, the display driver circuitry must be placed on the same glass plate using the thin film semiconductor used in the pixel circuitry. By placing the driver circuitry on the glass substrate with the pixel circuits the connections to the computer are reduced to only a couple dozen lines. The catch, however, is that while the pixel circuit operates at fairly low speed (in the kilohertz range), the driver circuits operated in the megahertz range—a thousand times faster than a-Si—can handle the speed.

The speed of a semiconductor increases as the material progresses from amorphous to single crystalline. The industry could not use single crystalline silicon (x-Si) so it decided to convert the a-Si to poly-crystalline silicon (p-Si) using heated annealing steps. In the beginning the industry did this by depositing p-Si on quartz plates heated to 900 degrees Centigrade. Quartz, however, is too expensive for most display applications; thus, methods were developed to create p-Si from a-Si using laser anneals which would locally heat the deposited a-Si to high temperature, but would not heat the glass substrate to the melting point. This method produced p-Si with enough speed to put the drivers on the glass substrate. The cost, however, was still high due to the cost of high-powered lasers. P-Si is a much different material than a-Si. For one thing a-Si does not have to be doped the way x-Si in the IC industry has to be, but p-Si does require dopants to produce the desired electrical contact characteristics. P-Si also does not make a very good on off switch. P-Si is very difficult to make uniformly due to the scanning of the laser anneal. These problems with p-Si have to be compensated for by more elaborate circuitry.

The LCD is a low powered display which can use a-Si for the active matrix, but requires p-Si if the display driving circuits are to be produced on the glass using a thin film semiconductor. For emissive displays, that is, for displays that use light-emitting diodes, the active matrix is not just a carrier of data, but now must carry the power that produces the light by which one sees the display. A-Si is not an option and the industry has turned to p-Si, which has the performance capability to run emissive displays.

The newest emissive displays are the field emission display (FED) and the organic light-emitting diode display (OLED) sometimes misnamed the organic EL or OEL. The present organic materials are all diodes, and thus, make OLEDs. There are several types of OLED materials. The first was invented at Kodak in the 1980s and is called the small molecule OLED. Later the polymer OLED was invented and then the metallo-organic material was invented. All of these display types including the FED require an active matrix to reach their full potential in resolution and image quality.

Kodak in partnership with Sanyo produced the first active matrix OLED display using p-Si for the pixel circuitry and also for drivers on the glass substrate. At the present time many companies are developing active matrix OLEDs using the standard p-Si circuitry developed by several companies in the industry over the last 15 years. In order to compensate for the problems of p-Si special pixel drive circuitry was designed. Such circuits are described in the paper entitled “Poly-Si Driving Circuits for Organic EL Displays,” paper 4925-20, Conference 4925A, Electronic Imaging 2001, San Jose, Calif. This paper explains the problems caused by the varying threshold voltages in a p-Si active matrix. The paper also alludes to other variances such as electron mobility variance across the matrix array. Because of these problems, it is unlikely that p-Si active matrixes will be applied to large (>15-inch) OLED displays, and that an alternative solution is necessary.

### SUMMARY OF THE INVENTION

The present invention is directed to thin film transistors having improved performance. More particularly, the thin film transistor employs cadmium selenide as the semiconductor active layer. Using the improved transistor structure allows the formation of flat screen displays in which the pixels, pixel drive circuits and the peripheral drive circuits are formed in the same steps on a supporting suitable substrate.

### BRIEF DESCRIPTION OF THE DRAWINGS

The invention together with its advantages will be better understood by reference to the following description together with the accompanying drawings in which:

FIG. 1 is a pixel a-Si circuit used in the active matrix to drive an LCD.

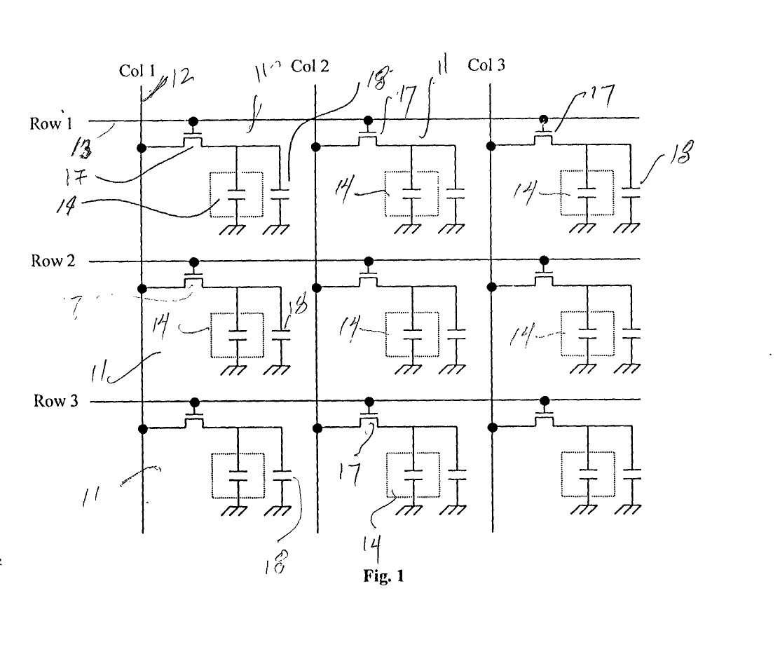

FIG. 2 is a pixel p-CdSe circuit used in the active matrix to drive an OLED.

FIG. 3 is a cross-sectional view of the pixel p-CdSe circuit of FIG. 2.

### DESCRIPTION OF THE PREFERRED EMBODIMENT

In accordance with the present invention, a suitable substrate is chosen according to the application of the flat panel display. For example, for a flexible substrate Kapton or PES plastic substrate is used. For other type displays, glass or insulated metal substrates can be used. In most light-emitting diode (LED) displays, the light is emitted down through the substrate so that the substrate must be transparent. All displays employ pixels which are driven to provide light. The older type displays employed liquid crystal (LCD) pixels in which the drive circuit was a sample-and-hold circuit comprising a single thin film transistor (TFT) and a capacitor. Displays under development today use light-emitting diodes (LEDs) such as organic light-emitting diodes (OLEDs) and field emission diodes (FEDs). Thin film transistor matrices are employed to drive the light-emitting diodes. It is advantageous to use a semiconductor active material for the thin film transistor circuits in which the same material is used in the display drive and control circuits whereby all circuits can be formed at the same time on the display substrate. In accordance with the present invention, the active semiconductor material is polycrystalline cadmium selenide.

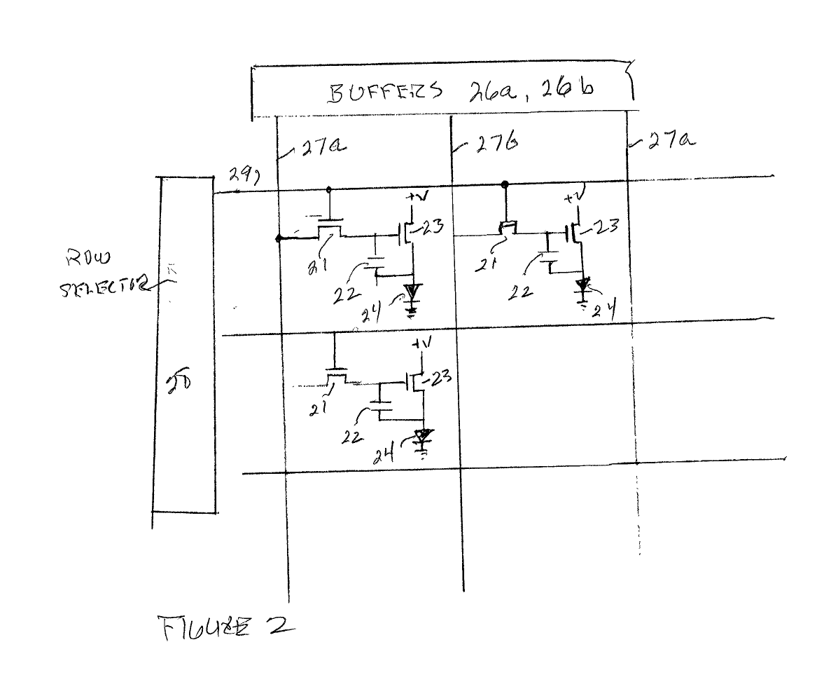

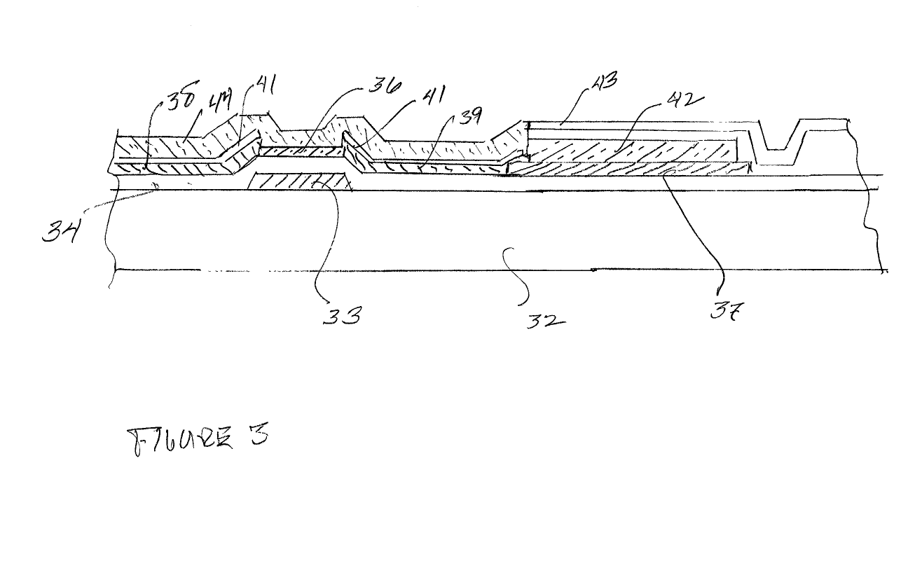

FIG. 3 is a section view of an active matrix pixel drive employing a thin film transistor having a cadmium selenide semiconductor layer. An active matrix pixel is described by describing its fabrication. A chromium film is formed on a suitable transparent substrate 32 such as glass. By masking and etching gate electrodes 33 are defined on the surface of the substrate. A silicon oxide film 34 is formed on the surface of the substrate and over the gate substrate to serve as a gate oxide. A cadmium selenide channel region 36 is formed on the oxide film opposite the gate electrode. A transparent ITO electrode 37 which forms the anode of the light-emitting diode is formed on the silicon oxide layer adjacent to channel 36. Chromium source 38 and drain 39 electrodes are deposited on the oxide with the drain electrode 39 connecting to the anode 37. An aluminum layer 41 is formed on the source and drain electrodes. OLED material 42 is deposited on the anode 37. A conductive cathode layer 43 which serves as a mirror is formed on the OLED and oxide layer. The cathode layer will be common for all pixels. A protective oxide coating 44 is applied to the remainder of the structure. With reference to FIG. 2, the anode 37 is connected to the voltage source +V via the channel 36 and the gate to the thin film transistor 21, not shown but formed at the same time as are the drive circuits and the capacitor 22, FIG. 2. The cathode 43 is connected to circuit ground.

Thus, there has been provided thin film transistors which can be employed in LED, LCD and drive circuits and the control circuits of flat panel displays, particularly displays employing OLEDs and FEDs.

What is claimed is:

1. A flat panel display comprising
a plurality of display pixels,
a matrix of thin film transistors for driving said pixels, each thin film transistor including a gate, source, drain and channel electrode characterized in that said channel electrode comprises cadmium selenide.

2. A flat panel display as in claim 1 in which the matrix of display pixels is arranged in columns and rows and in which the column and row transistors are driven by column and row drive thin film transistor circuits carried by the substrate in which the thin film transistors include cadmium selenide as the active semiconductor.

3. A flat panel display as in claim 2 in which said thin film transistors are field effect transistors having cadmium selenide channels.

4. A flat panel display as in claims 1, 2 or 3 in which the display pixel is a liquid crystal display driven by a single transistor.

5. A flat panel display comprising a matrix of rows and columns of light-emitting diodes formed on a substrate,
a thin film transistor circuit associated with each light-emitting diode comprising a first thin film field effect transistor having its source, channel and drain electrodes in series with said light-emitting diodes between a voltage source and a common electrode, a second thin film field effect transistor having its source, channel and drain electrodes with the drain connected to the gate electrode of the first field effect transistor and the source electrode adapted to be connected to a column control voltage and a gate electrode adapted to be connected to a line control voltage,
said first and second transistors having cadmium selenide channels, and
a capacitor connected between the drain electrodes of said first and second thin film transistors.

6. A flat panel display as in claim 5 including row and column drive circuits carried by the substrate, said drive circuits including thin film transistors which have cadmium selenide as the active semiconductor.

7. A flat panel display as in claim 6 in which said thin film transistors are field effect transistors with cadmium selenide channels.

8. A flat panel display comprising
a matrix of light-emitting diodes,
a matrix of thin film field-effect transistor circuits for driving said light-emitting diodes characterized in that said field effect transistors have cadmium selenide channels.

9. A flat panel display as in claim 8 in which said light-emitting diodes are organic light-emitting diodes.

10. A flat panel display as in claim 8 in which said light-emitting diodes are field emission diodes.
